(19) United States
(12) Patent Application Publication
(10) Pub. No.: US 2006/0008765 A1
(43) Pub. Date: Jan. 12, 2006

(54) Dental delivery unit accessories

(76) Inventor: Mark G. Conners, Pittsford, NY (US)

Correspondence Address: Laurence S. Roach, Esq.;Law Office of Thomas R. FitzGerald, Suite 210, 16 E. Main Street, Rochester, NY, 14614-1803, US

(21) Appl. No.: 10/889,284

(22) Filed: Jul. 12, 2004

(51) Int. Cl. A61C 1/02

(52) U.S. Cl. 433/98

(57) ABSTRACT

A cradle switch plug is placed into the cradle of a dental instrument in a dental delivery unit to deactivate the instrument thereby allowing the instrument to remain at the ready without endangering or spraying the user and/or assistants and/or patients. In addition, when an instrument is removed from an air fitting a blind air fitting plug is screwed into the air fitting. The air plug prevents entry of debris into the air fitting and/or air ports thereof. The air plug also enables proper seating of the air fitting within the cradle and, thus, actuation of the cradle switch.

### BACKGROUND AND SUMMARY

Embodiments of the present invention relate to machines used in dentistry. More specifically, embodiments of the present invention relate to accessories disabling dental air-powered tools, such as drills and the like, without requiring replacement of the tools in their cradles.

Embodiments relate to improvements in a dental delivery unit. In particular, the present invention provides a cradle switch plug for activating a cradle switch in a dental tool holder. Generally, the cradle switch plug activates the cradle switch to thereby disable an instrument without that instrument being disposed within the cradle, such as an instrument that is only temporarily not being used but which, for a variety of reasons, the user does not wish to return to the cradle. Additionally, embodiments provide a threaded air fitting plug that covers the open end, i.e., the air fitting, of an unused air supply hose and which is configured or shaped to enable (or not interfere with) the proper seating of the air fitting within the cradle and activation of the cradle switch to disconnect the hose from or deactivate the supply of pressurized air to the hose. Alternatively, embodiments can employ a combination of a cradle switch plug and a threaded air fitting plug to provide both functions.

Typical dental delivery units, such as that shown in U.S. Pat. No. 6,419,487, include a source of motive fluid, such as compressed air, to which at least one hose is attached. The hose leads and provides motive fluid to a tool, such as a turbine drill, that a dentist or assistant uses to work on a patient's teeth. The hose can also carry exhaust motive fluid, can supply water and air for irrigation and other purposes, and provide a fiber optic conduit, among other items, depending on the particular features desired by the end user. Typically, a switch, such as a foot pedal, enables and controls the amount of power used by the tool. Additionally, a tool holder preferably includes a “kill switch” or cradle switch that shuts off the supply of motive fluid to the tool when it rests in its cradle and activates the switch. A plurality of hoses is included in most dental delivery units, each hose with its own respective cradle and corresponding cradle switch. The cradle “kill switches” allow power to travel to their respective hoses until the hoses are returned to their cradles thereby activating the switch.

Upon occasion, the user will need to have one tool handy while using a second tool and will set the first tool down. Because the cradle switches allow power to travel to their hoses until they are returned to their cradles, both tools will continue to receive power in this scenario. Thus, when the second tool is used, the first will also be activated, spraying people and objects or worse. Thus, there is a need for a way to readily turn off power to a dental tool without replacing it in its holder.

The tools on the hoses of a delivery unit are typically interchangeable. When a tool is removed from its hose, the end cap of the hose is exposed, leaving ports in the end cap, such as air supply and exhaust ports, vulnerable to debris and other non-sterile material that could, among other things, infect the patient. Thus, there is a need for an easy way to keep debris and/or other non-sterile material from entering the ports on an end cap of such hoses.

Embodiments provide a cradle switch plug that fits into a hose cradle, interacting with its kill switch to turn off power to the respective hose. Thus, if the user wants to use a second tool without replacing the first tool in its cradle or removing it from its hose, the user simply places the plug in the cradle to deactivate the tool.

Embodiments also provide a threaded blind air fitting plug for a dental delivery air hose. When a tool is removed from its hose, the blind plug can be screwed on in its place to prevent material from entering ports in the end of the hose and to enable the air fitting to activate the cradle switch to thereby deactivate the hose.

Embodiments further provide for a combined cradle switch plug and blind plug in which one end of a cylinder is shaped as the cradle switch plug and the other is threaded to fit on the end of a hose. Alternatively, the cradle switch plug can include threads into which the blind plug can be screwed so that when the user wishes to use the blind plug, he or she unscrews the blind plug from the cradle switch plug, then screws the blind plug onto the air fitting end cap of the hose.

The above and other features of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 shows a typical dental delivery unit with which embodiments can be used.

FIG. 2 shows a typical dental delivery unit tool support with five cradles with which embodiments can be used.

FIG. 3 is a schematic diagram showing a cradle switch plug according to embodiments.

FIG. 4 is a schematic diagram showing a blind air fitting plug according to embodiments.

FIG. 5 is a schematic plan diagram of an air fitting with which embodiments can be used and showing ports in the end of the fitting.

FIG. 6 is a schematic diagram of an air fitting and a blind plug according to embodiments, the plug not being screwed onto the air fitting.

FIG. 7 is a schematic diagram of an air fitting and a blind plug according to embodiments, the plug being screwed onto the air fitting.

FIG. 8 is a schematic diagram of a dental delivery unit with which embodiments have been employed.

FIG. 9 is a schematic diagram of a combined cradle switch plug and blind plug according to embodiments.

### DESCRIPTION

While the present invention may be embodied in many different forms, there is described herein in detail an illustrative embodiment with the understanding that the present disclosure is to be considered as an example of the principles of the invention and is not intended to limit the invention to the illustrated embodiment.

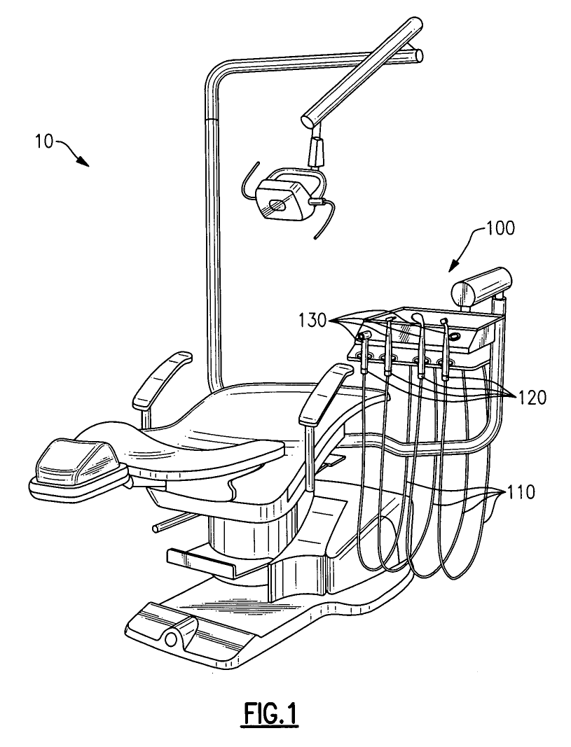

Typical dental delivery units, such as that shown in U.S. Pat. No. 6,419,487, include a source of motive fluid, such as compressed air, to which at least one hose is attached. See FIG. 1, which shows a typical delivery unit 10 with a tray 100 supporting a plurality of hoses 110 that end in air fittings 120 to which are attached tools or instruments 130. Each hose 120 leads and provides motive fluid to a tool 130, such as a turbine drill, that a dentist or assistant uses to work on a patient's teeth. The hose can also carry exhaust motive fluid, can supply water and air for irrigation and other purposes, and provide a fiber optic conduit, among other items, depending on the particular features desired by the end user. Typically, a switch (not shown), such as a foot pedal, enables and controls the amount of power used by the tool 130. Additionally, a tool holder or cradle 200 in the tray 100 preferably includes a “kill switch” (not shown) such that motive fluid is not sent to the tool 130 when it rests in its cradle 200. Each instrument 130 generally has its own respective cradle 200. The cradle “kill switches” allow power to travel to their respective tools 130 until they are returned to their cradles 200.

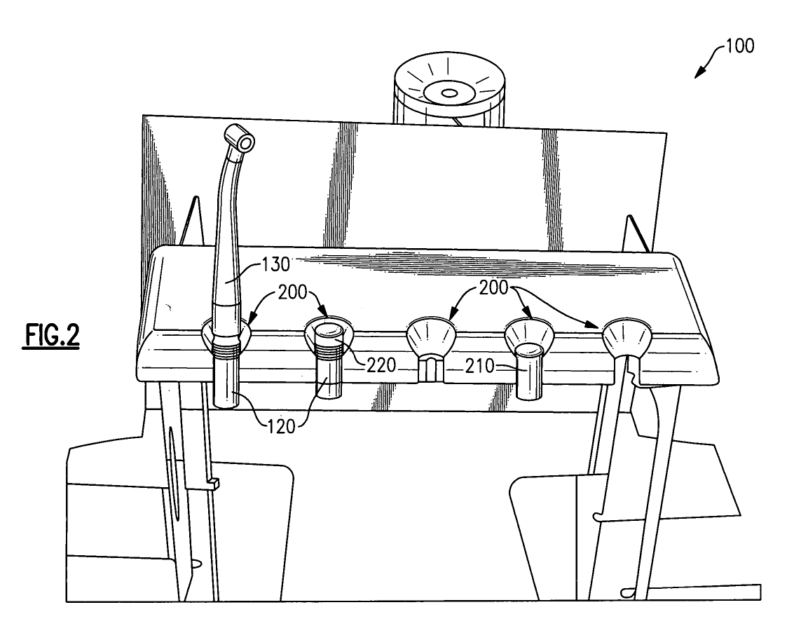

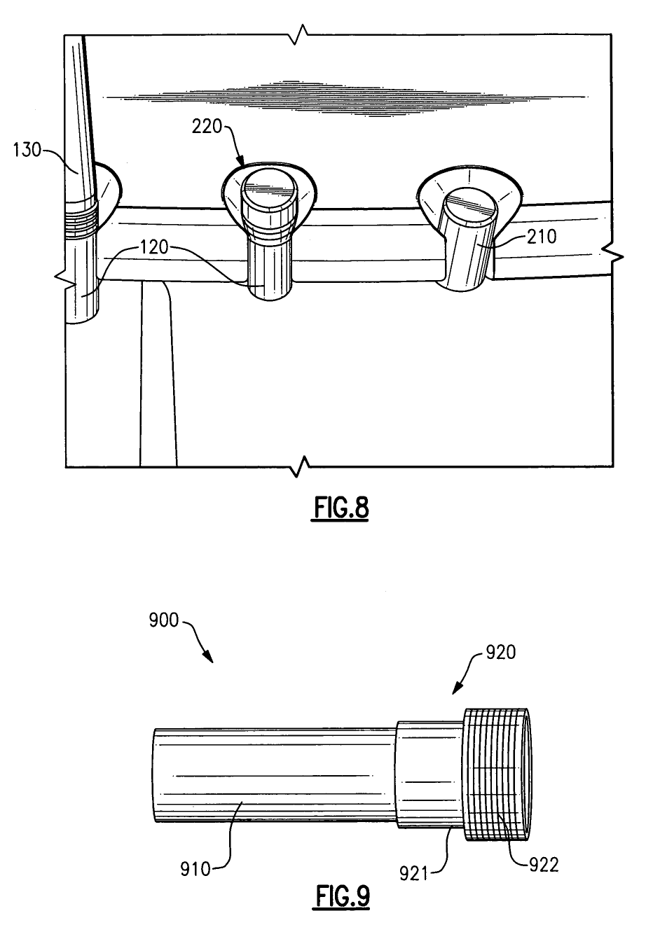

To enable a user to have one tool handy while using a second tool without power going to the first tool, embodiments provide a cradle switch plug 210, as seen in FIGS. 2, 3, and 8. The switch plug 210 fits into a cradle 200, interacting with its kill switch to turn off power to the respective hose 110 and tool 130. Thus, if the user wants to use a second tool without replacing the first tool in its cradle or removing it from its hose, the user simply places the switch plug in the cradle to deactivate the tool.

To ensure proper functioning, the switch plug 210 preferably has a contour substantially identical to that of an air fitting 120 on the hose 110 and to which the tool 130 is attached. Additionally, the switch plug 210 must be of sufficient weight to activate the kill switch of the cradle 200. Furthermore, the switch plug 210 must be constructed of a material, or with a finish, that is easily cleaned, sterilized, durable, and resistant to corrosion and fluids.

Preferably, embodiments use stainless steel as the primary material for the switch plug 210, thus providing adequate weight and substantially eliminating corrosion of the switch plug 210. Although in the embodiment shown and descried the plug 210 is preferably constructed of stainless steel, it is to be understood that the switch plug 210 of the present invention can be alternately configured and constructed of other suitable materials having the described characteristics, such as, for example, other metals, weighted or heavier plastics, or from any other suitable material or with a finish that is easily cleaned, sterilized, durable, and resistant to corrosion and fluids.

Yet another alternative is packaging or enclosing the plug 210 in a sterilized package or packaging material that is replaced and/or disposed of after each use.

The tools on the hoses of a delivery unit are typically interchangeable. When a tool is removed from its hose, the end cap of the hose 130 or its air fitting 120 is exposed. Embodiments contemplate a blind air fitting plug 220 that threads onto the end cap of the hose 130 or its air fitting 120 and has a contour configured that enables (or does not interfere with) proper seating of the hose/air fitting in the cradle and, thus, the activation of the cradle switch by the end cap of the house 130 or its air fitting 120. The blind air fitting plug 220, of course, must be of sufficient weight to activate the kill switch of the cradle.

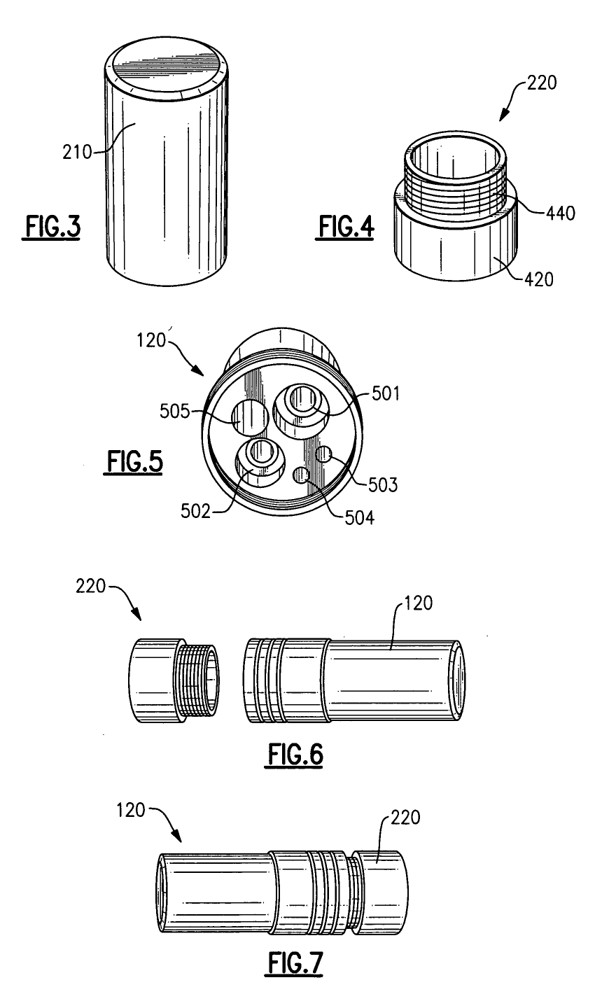

An example of a fitting plug 220 according to embodiments is shown in FIGS. 2-4 and 6-8. FIG. 5 shows an example of an end of a hose 130 or its air fitting 120 including ports, such as air supply and exhaust ports 501, 502, as well as water supply 503, spray air supply 504, and fiber optic conduit 505. As seen in FIG. 4, embodiments of the fitting plug 220 preferably include threads 410 and a blank end cap 420 sized to screw into the air fitting 120 or hose 130. When a tool 130 is removed from its hose 110, the blind plug 220 can be screwed on in its place thereby preventing material from entering ports in the end of the hose and enabling the air fitting 120 to properly seat within the cradle and actuate the cradle switch.

Embodiments further provide for a combined cradle switch plug and blind plug, as seen in FIG. 9. The combined plug 900 can comprise one end 910 of a cylinder shaped like a cradle switch plug 210 as described above. The other end 920 of the combined plug 900 can have a portion 921 similar to the blind end cap 410 of the blind air fitting plug described above, as well as a threaded portion 922 to fit on the end of a hose 130. Alternatively, a cradle switch plug 210 can include threads into which the blind plug 220 can be screwed so that when the user wishes to use the blind plug 220, he or she unscrews the blind plug 220 from the cradle switch plug 210, then screws the blind plug 220 onto the air fitting end cap of the hose.

While various illustrative embodiments of the present invention described above have been presented by way of example only, and not limitation, it will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A dental delivery unit accessory comprising a switch plug and a blind plug, the switch plug comprising a substantially frustoconical portion sized to fit a delivery unit cradle and activate a cradle switch associated therewith, the blind plug comprising a cap and a threaded portion, the threaded portion being sized to screw into an end of an air fitting, the cap configured for enabling the air fitting to properly seat within the cradle and activate the cradle switch, the cap sealing the air fitting to thereby prevent debris from entering at least one port of the air fitting.

2. The accessory of claim 1 wherein the switch plug and blind plug are a single piece of material, the switch plug being formed in one portion of the piece and the blind plug being formed in another portion of the piece.

3. The accessory of claim 1 wherein the threaded portion of the blind plug is configured for threading into an end of the switch plug when the blind plug is not in use in an air fitting.

4. A dental delivery unit accessory comprising means for activating a cradle switch and means for sealing an end of an air fitting.

5. The accessory of claim 4 wherein the means for activating comprises a substantially frustoconical body portion sized to fit a delivery unit instrument cradle.

6. The accessory of claim 4 wherein the means for sealing comprises a threaded portion that screws into an air fitting of a delivery unit and a cap portion that seals and protects the air fitting from debris.

7. The accessory of claim 4 wherein the means for activating comprise one portion of a body and the means for sealing comprise another portion of the body.

8. The accessory of claim 7 wherein the body is substantially cylindrical and the means for sealing comprises threads at one end of the body.

9. The accessory of claim 8 wherein the means for activating comprise a tapered cylindrical portion at an opposite end of the body from the means for sealing.

10. A dental instrument deactivation article comprising a substantially cylindrical body with a tapered, substantially frustoconical portion sized to fit a cradle of a dental delivery unit.

11. A dental delivery unit instrument deactivation method comprising providing a switch plug substantially identical in countour to an air fitting to which the instrument is attached, removing the instrument from a respective cradle, placing the switch plug into the cradle, thereby actuating a cradle switch and deactivating the instrument.

12. A dental delivery unit air fitting debris entry prevention method comprising providing a blind plug, removing an instrument from an air fitting, and placing the blind plug on the air fitting.

13. The method of claim 12 wherein providing a blind plug comprises providing an end cap portion and providing a threaded portion sized to screw into the air fitting.

14. The method of claim 12 wherein placing the blind plug on the air fitting comprises screwing the blind plug into the air fitting.

15. The method of claim 12, wherein the blind plug end cap is shaped to enable the air fitting to properly seat in the cradle and actuate the cradle switch.

16. A dental delivery unit accessory kit comprising:
a cradle switch deactivation article; and
a blind air fitting plug.

17. The kit of claim 16 wherein the cradle switch deactivation article comprises a cradle switch plug formed to fit an instrument cradle of a dental delivery unit.
